(19) United States
(12) Patent Application Publication
(10) Pub. No.: US 2026/0032499 A1
(43) Pub. Date: Jan. 29, 2026

(54) ERROR COMPENSATION PARAMETER CALCULATION METHOD AND APPARATUS

(71) Applicant: HUAWEI TECHNOLOGIES CO., LTD., Shenzhen (CN)

(72) Inventors: Ping ZHANG, Shenzhen (CN); Jiajin LUO, Shenzhen (CN); Baojian ZHOU, Shenzhen (CN); Yang YU, Shenzhen (CN); Xiaohui PENG, Shenzhen (CN)

(73) Assignee: HUAWEI TECHNOLOGIES CO., LTD., Shenzhen (CN)

(21) Appl. No.: 19/345,377

(22) Filed: Sep. 30, 2025

Related U.S. Application Data
(63) Continuation of application No. PCT/CN2023/085806, filed on Mar. 31, 2023.

(51) Int. Cl. H04W 24/10; H04W 64/00; H04W 76/10

(52) U.S. Cl. CPC H04W 24/10; H04W 64/00; H04W 76/10

(57) ABSTRACT

An error compensation parameter calculation method and an apparatus. The method includes: a first node obtains first measurement information of a first measurement object, where the first measurement information is obtained by measuring the first measurement object according to a first measurement method; the first node obtains first status information of the first measurement object; and the first node calculates an error compensation parameter based on the first measurement information and the first status information, where the error compensation parameter is used to correct measurement information that is of a measurement object and that is obtained through measurement according to the first measurement method. In this way, the first node calculates the error compensation parameter to compensate for a system error of sensing and communication, improve accuracy of the measurement information of the measurement object, and improve communication performance.

### CROSS-REFERENCE TO RELATED APPLICATIONS

This application is a continuation of International Application No. PCT/CN2023/085806, filed on Mar. 31, 2023, the disclosure of which is hereby incorporated by reference in its entirety.

### TECHNICAL FIELD

The embodiments relate to the field of communication technologies and to an error compensation parameter calculation method and an apparatus.

### BACKGROUND

In an integrated sensing and communication scenario, a sensing node (for example, a cellular base station) may receive an echo of a radio frequency signal in a passive environment, to complete a plurality of sensing tasks for sensing and communication such as detection, positioning, speed measurement, tracking, and imaging on a to-be-sensed measurement object in the passive environment.

For example, the sensing node may complete sensing and communication according to a measurement method of non-cooperative measurement, to determine measurement information of the to-be-sensed measurement object. However, in some embodiments, due to impact of array installation and a hardware circuit, the measurement information of the measurement object that is determined according to the method may have a system error (including a site location error and a measurement error). Therefore, the measurement information determined according to the method deviates from actual information. Consequently, communication performance deteriorates.

### SUMMARY

Embodiments provide an error compensation parameter calculation method and an apparatus, to correct measurement information of a measurement object that is determined according to a first measurement method, so as to improve accuracy of the measurement information of the measurement object, and improve communication performance.

According to a first aspect, an embodiment provides an error compensation parameter calculation method. The method includes: a first node obtains first measurement information of a first measurement object, where the first measurement information is obtained by measuring the first measurement object according to a first measurement method; the first node obtains first status information of the first measurement object; and the first node calculates an error compensation parameter based on the first measurement information and the first status information, where the error compensation parameter is used to correct measurement information that is of a measurement object and that is obtained through measurement according to the first measurement method.

According to this method, the first node may calculate the error compensation parameter by using the first measurement object whose first status information is known, to compensate for a system error, thereby improving accuracy of measurement information obtained by the first node or another node according to the first measurement method, and improving communication performance.

In a possible embodiment, after the first node calculates the error compensation parameter based on the first measurement information and the first status information, the first node may further measure a second measurement object according to the first measurement method, to obtain second measurement information; and the first node performs error compensation on the second measurement information based on the error compensation parameter; or the first node sends the error compensation parameter to a second node.

According to this embodiment, the first node may correct, based on the error compensation parameter, the measurement information that is of the measurement object and that is obtained through measurement according to the first measurement method; or the first node may send the error compensation parameter obtained through calculation to the second node, so that the second node corrects the measurement information that is of the measurement object and that is obtained through measurement according to the first measurement method. This embodiment improves accuracy of the measurement information of the measurement object. In addition, when the first node sends the error compensation parameter to the second node, a computing resource of the second node may not be occupied in an error calculation process, thereby saving the computing resource of the second node.

In a possible embodiment, the first node may calculate the error compensation parameter in the following manner: the first node receives node status information of a third node from the third node via a link between the first node and the third node; or the first node obtains the node status information of the third node through calculation; and the first node calculates the error compensation parameter based on the node status information of the third node, the first measurement information, and the first status information.

According to this embodiment, the first node may determine the error compensation parameter with reference to the node status information of the third node, thereby improving accuracy of the error compensation parameter.

In a possible embodiment, the step or operation that the first node obtains the first measurement information of the first measurement object includes: the first node measures the first measurement object according to the first measurement method, to obtain the first measurement information; or the first node receives the first measurement information from a fourth node.

According to this embodiment, the first node may perform the first measurement method to obtain the first measurement information, or the first node may indirectly obtain the first measurement information via the fourth node, thereby improving flexibility and accuracy of the error compensation parameter calculation method.

In a possible embodiment, the step or operation that the first node obtains the first status information of the first measurement object includes: the first node receives the first status information from the first measurement object via a link between the first node and the first measurement object; or the first node obtains the first status information through calculation; or the first node receives the first status information from a fifth node.

According to the foregoing embodiment, the first node may obtain the first status information of the first measurement object in a link communication or calculation manner, thereby improving flexibility and accuracy of the error compensation parameter calculation method.

In a possible embodiment, the step or operation that the first node receives the first status information from the fifth node includes: the first node sends a first request to the fifth node, where the first request carries an identifier of the first measurement object, and the first request is used to request the first status information of the first measurement object; and the first node receives a first response from the fifth node, where the first response includes the first status information; or the first node receives a second request from the fifth node, where the second request carries an identifier of the first measurement object, and the second request indicates the first node to receive the first status information of the first measurement object from the fifth node; and the first node receives a first message from the fifth node, where the first message includes the first status information.

In this way, the first node initiates an error compensation request, or the fifth node initiates an error compensation request, so that the first node obtains the first status information of the first measurement object. This makes the error compensation parameter calculation method more flexible.

In a possible embodiment, the error compensation parameter includes at least one of the following: a location error compensation parameter, an attitude angle error compensation parameter, and a measurement error compensation parameter.

In a possible embodiment, the first node is any one of the following: a terminal device, a network device, and a location management function (LMF) network element.

According to a second aspect, an embodiment provides a communication apparatus, including modules configured to perform the steps or operations in the first aspect. Optionally, the communication apparatus includes a communication module and a processing module, the communication module is configured to receive and send data, and the processing module is configured to perform, based on the communication module, the method provided in the first aspect. For example, the communication apparatus may be used in the foregoing first node.

According to a third aspect, an embodiment provides a communication device, including a communication module, a memory, and a processor. The communication module is configured to receive and send data. The memory is configured to store program instructions and data. The processor is configured to read the program instructions and the data in the memory, to implement the method provided in the first aspect. For example, the communication device may be the foregoing first node.

According to a fourth aspect, an embodiment provides a communication device, including at least one processing element and at least one storage element. The at least one storage element is configured to store a program and data, and the at least one processing element is configured to perform the method provided in the first aspect. For example, the communication device may be the foregoing first node.

According to a fifth aspect, an embodiment further provides a computer program. When the computer program is run on a computer, the computer is enabled to perform the method provided in the first aspect. Optionally, the computer may be the foregoing first node, or may be the foregoing communication apparatus or communication device.

According to a sixth aspect, an embodiment further provides a non-transitory computer-readable storage medium. The non-transitory computer-readable storage medium stores a computer program, and when the computer program is executed by a computer, the computer is enabled to perform the method provided in the first aspect. Optionally, the computer may be the foregoing first node, or may be the foregoing communication apparatus or communication device.

According to a seventh aspect, an embodiment further provides a chip. The chip is configured to read a computer program stored in a memory, to perform the method provided in the first aspect. Optionally, the chip may include a processor and the memory. The processor is coupled to the memory, and is configured to read the computer program stored in the memory, to implement the method provided in the first aspect.

According to an eighth aspect, an embodiment further provides a chip system. The chip system includes a processor, configured to support a computer apparatus in implementing the method provided in the first aspect. In a possible embodiment, the chip system further includes a memory, and the memory is configured to store a program and data that may be for the computer apparatus. The chip system may include a chip, or may include a chip and another discrete component.

For effects that can be achieved in any one of the second aspect to the eighth aspect, refer to the effects that can be achieved in any possible embodiment in the first aspect. No repeated description is provided.

### BRIEF DESCRIPTION OF DRAWINGS

FIG. 1 is a diagram of an architecture of a communication system according to an embodiment;

FIG. 2 is a schematic flowchart of an error compensation parameter calculation method according to an embodiment;

FIG. 3 is a schematic flowchart of another error compensation parameter calculation method according to an embodiment;

FIG. 4A is a diagram of an architecture of another communication system according to an embodiment;

FIG. 4B is an example diagram of an error compensation parameter calculation method according to an embodiment;

FIG. 5A is a diagram of an architecture of another communication system according to an embodiment;

FIG. 5B is an example diagram of an error compensation parameter calculation method according to an embodiment;

FIG. 6A is a diagram of an architecture of another communication system according to an embodiment;

FIG. 6B is an example diagram of an error compensation parameter calculation method according to an embodiment;

FIG. 7A is a diagram of an architecture of another communication system according to an embodiment;

FIG. 7B is an example diagram of an error compensation parameter calculation method according to an embodiment;

FIG. 8 is a diagram of a structure of a communication apparatus according to an embodiment; and

FIG. 9 is a diagram of a structure of a communication device according to an embodiment.

### DETAILED DESCRIPTION OF EMBODIMENTS

To make the objectives, solutions, and advantages clearer, the following further describes the embodiments in detail with reference to accompanying drawings. It may be understood that the described embodiments are provided for illustration of embodiments and are not intended to limit.

The following describes some terms in the embodiments, to facilitate understanding of a person skilled in the art.

(1) Non-cooperative measurement: generally refers to a technology used by a radar to detect a location of a measurement object (including a non-cooperative target object) in a search space domain. Location information of the non-cooperative target object can be directly measured by only a sensor, and cannot be obtained by using any other means. For example, the non-cooperative target object may be a terminal device, a vehicle, a pedestrian, a building, an incoming missile, an enemy aircraft, a failed or faulty spacecraft, an enemy spacecraft, and space debris in search space.

(2) Active cooperative target object: is a target object whose location information can be obtained through another cooperation channel in addition to being directly measured by a sensor. For example, both identity number (ID) information and status information of the active cooperative target object can be known. For example, the active cooperative target object may be a positioning reference unit or a positioning beacon system.

(3) Terminal device: is a device that provides voice and/or data connectivity for a user. The terminal device may also be referred to as user equipment (UE), a mobile station (MS), a mobile terminal (MT), or the like.

For example, the terminal device may be a handheld device with a wireless connection function, various in-vehicle devices, a roadside unit, or the like. Currently, some examples of the terminal device are: a mobile phone, a tablet computer, a notebook computer, a palmtop computer, a mobile internet device (MID), a smart point of sale (POS), a wearable device, a virtual reality (VR) device, an augmented reality (AR) device, a wireless terminal in industrial control, a wireless terminal in self-driving, a wireless terminal in remote surgery (remote medical surgery), a wireless terminal in a smart grid, a wireless terminal in transportation safety, a wireless terminal in a smart city, a wireless terminal in a smart home, various smart meters (such as a smart water meter, a smart electricity meter, and a smart gas meter), eLTE-DSA UE, a device with an integrated access and backhaul (IAB) capability, an in-vehicle electronic control unit (ECU), an in-vehicle computer, an in-vehicle cruise system, a telematics box (T-BOX), and the like.

(4) Network device: is a device that connects a terminal device to a wireless network in a communication system. As a node in a radio access network, the network device may also be referred to as a base station, and may also be referred to as a radio access network (RAN) node (or device), or an access point (AP).

Currently, some examples of the network device include: a next generation NodeB (gNB), a transmission and reception point (TRP), an evolved NodeB (eNB), a radio network controller (RNC), a NodeB (NB), an access point (AP), a base station controller (BSC), a base transceiver station (BTS), a home base station (for example, a home evolved NodeB or a home NodeB, HNB), a baseband unit (BBU), an enterprise LTE discrete spectrum aggregation (eLTE-DSA) base station, and the like.

In addition, in a network structure, the network device may include a central unit (CU) node and a distributed unit (DU) node. In this structure, protocol layers of an eNB in a long term evolution (LTE) system are split. Functions of some protocol layers are controlled by the CU in a centralized manner. Functions of some or all remaining protocol layers are distributed in the DU, and the CU controls the DU in a centralized manner.

(5) Location management function (LMF) network element: has main functions including interaction with a 5th generation mobile communication technology (5G) core network, to implement a positioning function of a communication device.

It may be noted that “a plurality of” in the embodiments means two or more than two. “At least one” means one or more.

In addition, it may be understood that in the descriptions, words such as “first” and “second” are used for distinguishing, and cannot be understood as an indication or implication of relative importance or an indication or implication of a sequence.

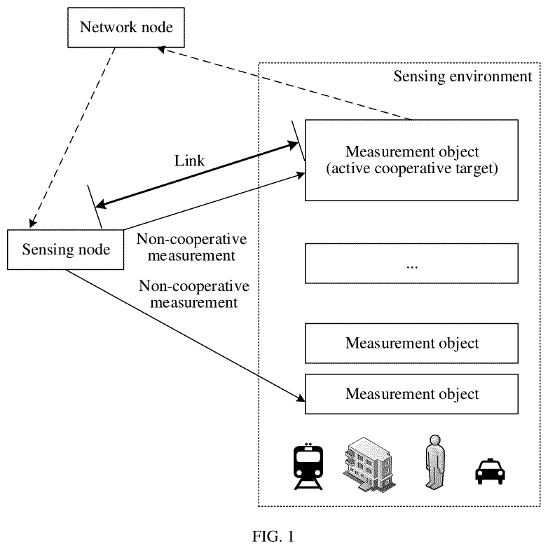

FIG. 1 is a diagram of a structure of a communication system according to an embodiment. As shown in FIG. 1, the communication system includes a sensing node and at least one measurement object in a sensing environment of the sensing node. The sensing environment may be an environment including objects such as a terminal device, a vehicle, a pedestrian, and a building. In the communication system, the sensing node may measure at least one measurement object according to a non-cooperative measurement method, to obtain measurement information of the at least one measurement object. Optionally, there may be one or more sensing nodes. The communication system may be deployed in a cellular positioning scenario, an integrated sensing and communication scenario, a multi-station network sensing scenario, or a vehicle network scenario. This is not limited. The sensing node may be a network device or a terminal device.

Optionally, the communication system shown in FIG. 1 may further include a network node. The network node may be used as a communication transit node between the sensing node and an active cooperative target object. The network node may be a network device or an LMF network element.

To correct measurement information of a measurement object, and improve accuracy of the measurement information of the measurement object, so as to improve communication performance, embodiments provide an error compensation parameter calculation method. An error compensation parameter corresponding to a measurement method is calculated by selecting a measurement object whose status information can be obtained in a sensing environment, to compensate for a system error of a sensing node.

With reference to FIG. 1, in embodiments, the at least one measurement object includes an active cooperative target object. The sensing node may implement link interaction with the active cooperative target object, or may measure the active cooperative target object according to a non-cooperative measurement method.

The following describes embodiments in detail with reference to the accompanying drawings.

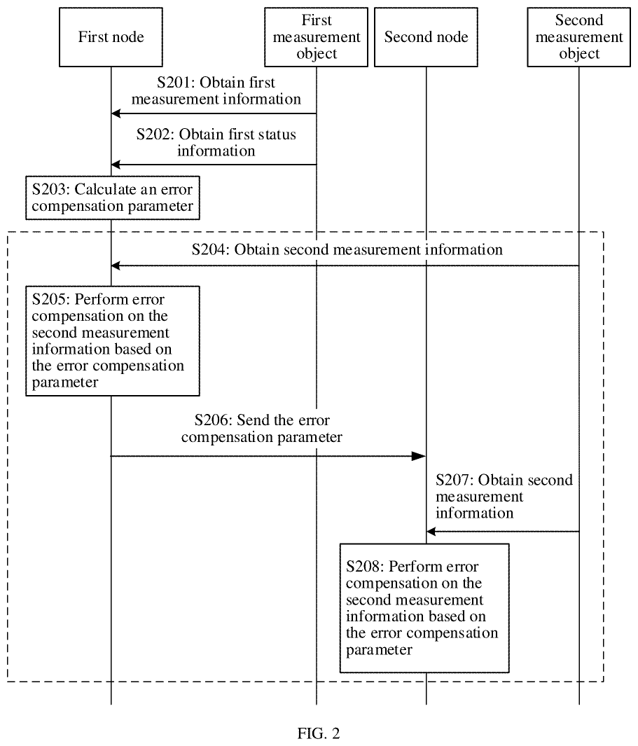

FIG. 2 is a schematic flowchart of an error compensation parameter calculation method according to an embodiment. The method is applicable to the communication system shown in FIG. 1. It may be noted that, in this embodiment, an error compensation parameter may be calculated by using a first node, or an error compensation parameter may be calculated through interaction between a first node and another node. The following describes nodes in this embodiment.

The first node is configured to calculate the error compensation parameter. In addition, the first node may further initiate error compensation parameter calculation (or referred to as error calculation), obtain measurement information of a measurement object according to a first measurement method, and perform error compensation on the measurement information obtained according to the first measurement method.

A second node may perform, based on the error compensation parameter, error compensation on the measurement information obtained according to the first measurement method.

A third node may obtain the measurement information of the measurement object according to the first measurement method, and may further send status information of the third node to the first node.

A fourth node may obtain the measurement information of the measurement object according to the first measurement method.

A fifth node may initiate error compensation parameter calculation (or referred to as error calculation).

It may be noted that in the method provided in this embodiment, the second node, the third node, the fourth node, and the fifth node may be different nodes, or any part or all of the nodes are a same node. This is not limited.

The following describes the method provided in this embodiment with reference to FIG. 2.

S201: the first node obtains first measurement information of a first measurement object, where the first measurement information is obtained by measuring the first measurement object according to the first measurement method. For example, the first measurement information may include a measurement location of the first measurement object, a measurement distance from the first measurement object, a measurement angle of the first measurement object, and a measurement speed of the first measurement object.

It may be understood that, using the communication system shown in FIG. 1 as an example, the first node may be a sensing node or a network node, and the first measurement object may be an active cooperative target object.

Optionally, the first node may be any one of the following: a terminal device, a network device, and an LMF network element. Optionally, the first measurement method may include but is not limited to non-cooperative measurement.

In a possible embodiment, the first node may obtain the first measurement information of the first measurement object in either of the following two manners.

Manner 1: the first node measures the first measurement object according to the first measurement method, to obtain the first measurement information.

For example, with reference to FIG. 1, when the first node is a sensing node, and the first measurement object is an active cooperative target object, the sensing node may perform non-cooperative measurement (for example, echo data processing and analysis) on the active cooperative target object according to a non-cooperative measurement method, to obtain the first measurement information.

Manner 2: the first node receives the first measurement information from the fourth node.

For example, with reference to FIG. 1, when the first node is a network node, the fourth node is a sensing node, and the first measurement object is an active cooperative target object, the network node may send a measurement request to the sensing node; the sensing node may respond to the measurement request, perform non-cooperative measurement (for example, echo data processing and analysis) on the active cooperative target object according to a non-cooperative measurement method to obtain the first measurement information, and send the first measurement information to the network node; and correspondingly, the network node receives the first measurement information from the sensing node.

According to this embodiment, the first node may obtain the first measurement information of the first measurement object in either of the foregoing manners, thereby improving flexibility and accuracy of the error compensation parameter calculation method.

S202: the first node obtains first status information of the first measurement object. The first measurement object may be an active cooperative target object, and the first node may obtain the first status information of the first measurement object according to a calculation requirement. For example, the first status information may include an actual location of the first measurement object and an actual speed of the first measurement object.

Optionally, in addition to obtaining the first status information of the first measurement object, the first node may further obtain ID information and timestamp information of the first measurement object.

In a possible embodiment, the first node may obtain the first status information of the first measurement object in any one of the following three manners.

Manner A: the first node receives the first status information from the first measurement object via a link between the first node and the first measurement object.

For example, with reference to FIG. 1, it is assumed that the first node is a sensing node, and the first measurement object is an active cooperative target object. The sensing node may establish a link between the sensing node and the active cooperative target object. The active cooperative target object may send ID information, timestamp information, and the first status information (for example, real-time status information) of the active cooperative target object to the sensing node via the link.

Manner B: the first node obtains the first status information through calculation.

For example, with reference to FIG. 1, it is assumed that the first node is a network node, and the first measurement object is an active cooperative target object. The network node may calculate the first status information of the active cooperative target object.

Manner C: the first node receives the first status information from the fifth node.

Optionally, the first status information is obtained by the fifth node through calculation, or the first status information is received by the first measurement object via a link between the fifth node and the first measurement object.

In a possible embodiment of Manner C, a process in which the first node receives the first status information includes the following two cases.

### Case 1 (the First Node Initiates Error Calculation):

The first node sends a first request to the fifth node, where the first request carries an identifier of the first measurement object, and the first request is used to request the first status information of the first measurement object; and the first node receives a first response from the fifth node, where the first response includes the first status information.

For example, with reference to FIG. 1, it is assumed that the first node is a sensing node, the fifth node is a network node, and the first measurement object is an active cooperative target object. The sensing node initiates the first request (also referred to as an error correction request) to the network node via an air interface, where the first request includes ID information of the active cooperative target object. Correspondingly, the network node obtains timestamp information and the first status information of the active cooperative target object in response to the first request. Further, the network node sends the first response to the sensing node, where the first response includes the timestamp information and the first status information of the active cooperative target object.

### Case 2 (the Fifth Node Initiates Error Calculation):

The first node receives a second request from the fifth node, where the second request carries an identifier of the first measurement object, and the second request indicates the first node to receive the first status information of the first measurement object from the fifth node; and the first node receives a first message from the fifth node, where the first message includes the first status information.

For example, with reference to FIG. 1, it is assumed that the first node is a sensing node, the fifth node is a network node, and the first measurement object is an active cooperative target object. The sensing node may receive the second request (also referred to as an error correction request) from the network node via an air interface, where the second request includes ID information of the active cooperative target object. The sensing node may receive the first message from the network node, where the first message includes timestamp information and the first status information of the active cooperative target object.

In this way, in Case 1, the first node initiates an error compensation request, or in Case 2, the fifth node initiates an error compensation request. In addition, in both cases, the first node can obtain the first status information of the first measurement object. This makes the error compensation parameter calculation method in the embodiments more flexible.

Optionally, a manner for calculation in Manner B and Manner C includes any one of the following: a radio access technology (RAT)-independent (RAT-independent) technology, a radio access technology-dependent (RAT-dependent) technology, and a hybrid positioning technology.

According to the foregoing embodiment, the first node may obtain the first status information of the first measurement object in any one of the foregoing manners, thereby improving flexibility and accuracy of the error compensation parameter calculation method.

It may be noted that an execution sequence of step or operation S201 and step or operation S202 may be exchanged, or step or operation S201 and step or operation S202 may be synchronously completed. This is not limited.

S203: the first node calculates an error compensation parameter based on the first measurement information and the first status information, where the error compensation parameter is used to correct measurement information that is of a measurement object and that is obtained through measurement according to the first measurement method.

Optionally, the error compensation parameter includes at least one of the following: a location error compensation parameter, an attitude angle error compensation parameter, and a measurement error compensation parameter. The location error compensation parameter indicates location errors of the sensing node (translational) in three different directions, the location error compensation parameter may be represented by Δp, and Δp includes three values: Δp^{x}, Δp^{y}, and Δp^{z}. The attitude angle error compensation parameter indicates a roll error, a pitch error, and a yaw error of the sensing node (rotational), the attitude angle error compensation parameter may be represented by Δζ, and Δζ includes three values: Δα, Δβ, and Δγ. The measurement error compensation parameter indicates system errors in measurement for a distance, an azimuth angle, and a pitch angle when the sensing node measures a measurement object, the measurement error compensation parameter may be represented by Δz, and Δz includes three values: Δρ, Δϕ, and Δη.

For example, with reference to FIG. 1, it is assumed that the first node is a sensing node, and the first measurement object is an active cooperative target object. The sensing node may obtain the error compensation parameter through calculation based on the first measurement information and the first status information of the active cooperative target object.

In a possible embodiment, when the first node is not a sensing node, the first node may obtain node status information of the sensing node in advance, and calculate the error compensation parameter by using the following two steps or operations.

Step or operation 1: the first node receives node status information of the third node from the third node via a link between the first node and the third node; or the first node obtains the node status information of the third node through calculation.

Optionally, a manner for calculation includes any one of the following: a RAT-independent technology, a RAT-dependent technology, and a hybrid positioning technology.

Step or operation 2: the first node calculates the error compensation parameter based on the node status information of the third node, the first measurement information, and the first status information.

For example, it is assumed that the first node is a network node, and the third node is a sensing node. The network node may receive node status information of the sensing node via a link between the network node and the sensing node, or the network node may obtain the node status information of the sensing node through calculation. The network node calculates the error compensation parameter based on the node status information of the sensing node, the first measurement information, and the first status information.

In this way, when the first node is not a sensing node, the first node may perform the foregoing steps or operations, so that the first node can determine the error compensation parameter by referring to the node status information of the sensing node, thereby improving accuracy of the error compensation parameter.

According to the method shown in the foregoing step or operation S201 to step or operation S203, the first node may calculate the error compensation parameter by using the first measurement object whose first status information is known, to compensate for a system error, thereby improving accuracy of measurement information of a measurement object that is obtained according to the first measurement method, and improving communication performance.

After determining the error compensation parameter, the first node may further correct, by using actions shown in steps or operations S204 and S205 or steps or operations S206 to S208, the measurement information of the measurement object that is obtained through measurement according to the first measurement method. Therefore, either the actions in steps or operations S204 and S205 or the actions in steps or operations S206 to S208 may be performed. It may be understood that the actions in steps or operations S204 and S205 and steps or operations S206 to S208 are all optional actions, for example, are performed only when the first node or the second node has a measurement requirement.

The following uses an example in which a to-be-measured measurement object is a second measurement object for description. The second measurement object may be any measurement object in the sensing environment shown in FIG. 1.

S204: the first node measures the second measurement object according to the first measurement method, to obtain second measurement information.

S205: the first node performs error compensation on the second measurement information based on the error compensation parameter.

For example, when the first node is a sensing node, the sensing node measures the second measurement object according to the first measurement method, to obtain the second measurement information; and the sensing node performs error compensation on the second measurement information based on the error compensation parameter determined in step or operation S203. It may be understood that, for an error compensation method, refer to an existing solution in the art. This is not limited.

In this way, the first node may correct, based on the error compensation parameter, the measurement information of the measurement object that is obtained through measurement according to the first measurement method, thereby improving accuracy of the measurement information of the measurement object, and improving communication performance.

S206: the first node sends the error compensation parameter to the second node.

Optionally, before step or operation S206 is performed, the first node may receive a third request from the second node, where the third request is used to request to obtain the error compensation parameter.

S207: the second node measures the second measurement object according to the first measurement method, to obtain second measurement information.

S208: the second node performs error compensation on the second measurement information based on the error compensation parameter.

For example, when the first node is a network node, and the second node is a sensing node, the sensing node sends the third request to the network node via an air interface; and the network node sends the error compensation parameter determined in step or operation S203 to the sensing node. Optionally, the sensing node may further measure the second measurement object according to the first measurement method, to obtain the second measurement information, and perform error compensation on the second measurement information based on the error compensation parameter. It may be understood that, for an error compensation method, refer to an existing solution in the art. This is not limited.

In this way, the first node may calculate the error compensation parameter, so that the second node corrects the measurement information of the measurement object that is obtained through measurement according to the first measurement method, thereby improving accuracy of the measurement information of the measurement object. In addition, a computing resource of the second node may not be occupied in an error calculation process, thereby saving the computing resource of the second node.

It may be noted that, in some scenarios, the second node is the same as the fourth node. When Manner 1 is used in step or operation S201, the actions in steps or operations S204 and S205 are performed. When Manner 2 is used in step or operation S201, the actions in steps or operations S206 to S208 are performed.

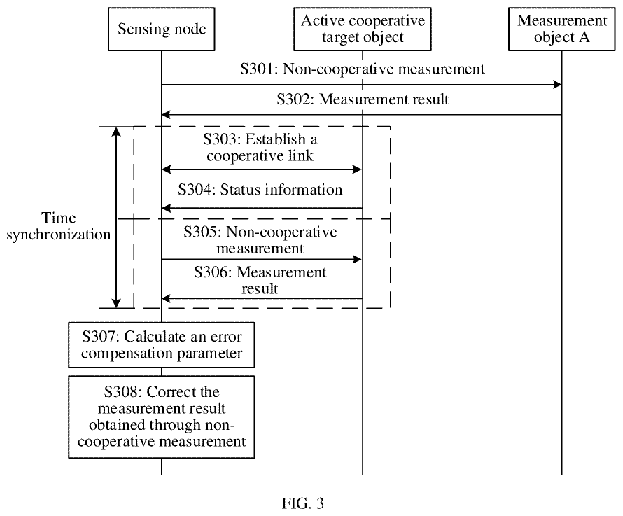

Based on the method provided in the embodiment shown in FIG. 2, this embodiment further provides an example of error compensation for non-cooperative measurement. In this example, a first node is the sensing node shown in FIG. 1, a first measurement object is the active cooperative target object shown in FIG. 1, and a second measurement object is any measurement object (for example, a measurement object A) shown in FIG. 1. The following describes a method and steps or operations for error compensation in this example with reference to a flowchart shown in FIG. 3.

S301: the sensing node may measure the measurement object A according to a non-cooperative measurement method.

S302: based on step or operation S301, the sensing node obtains a measurement result, where the measurement result includes measurement information of the measurement object A.

S303: the sensing node may establish a cooperative link with the active cooperative target object.

S304: the sensing node receives, via the cooperative link in step or operation S303, status information reported by the active cooperative target object, where the status information is the foregoing first status information.

The actions in step or operation S303 and step or operation S304 may be the same as or different from the action in step or operation S202.

S305: the sensing node may measure the active cooperative target object according to the non-cooperative measurement method.

S306: based on step or operation S305, the sensing node obtains a measurement result, where the measurement result includes measurement information of the active cooperative target object.

The actions in step or operation S305 and step or operation S306 may be the same as or different from the action in step or operation S201.

It may be understood that step or operation S303 and step or operation S304 may be performed synchronously with step or operation S305 and step or operation S306 in terms of time. Step or operation S304 is implemented based on step or operation S303, and step or operation S306 is implemented based on step or operation S305.

S307: the sensing node calculates an error compensation parameter based on the status information of the active cooperative target object determined in step or operation S304 and the measurement information of the active cooperative target object determined in step or operation S306.

The action in step or operation S307 may be the same as or different from the action in step or operation S203.

S308: the sensing node may correct, based on the error compensation parameter in step or operation S307, the measurement information obtained through non-cooperative measurement. For example, the sensing node may re-perform steps or operations S301 and S302, and correct the measurement result.

In this way, the sensing node may select an active cooperative target object in a sensing scenario, and correct, by using real-time status information and measurement information of the active cooperative target object, a system error generated when the sensing node performs non-cooperative measurement, thereby improving communication performance.

According to the method shown in step or operation S301 to step or operation S308, the sensing node may calculate the error compensation parameter by using the status information and the measurement information of the active cooperative target object, so that the sensing node compensates for a system error in the first measurement method, thereby improving accuracy of measurement information of a measurement object that is obtained according to the first measurement method, and improving communication performance.

Based on the method provided in the embodiment shown in FIG. 2, this embodiment further provides the following four examples based on different devices for initiating an error compensation calculation procedure, different computing devices for error compensation, and different links for transferring status information of a measurement object, so as to implement error compensation for non-cooperative measurement.

### Example 1

It is assumed that a measurement object B is any measurement object in the sensing environment shown in FIG. 1, and an active cooperative target object is a measurement object whose status information is known. As shown in the following Table 1, in this example, a terminal device initiates an error compensation calculation procedure, and calculates an error compensation parameter. In this example, status information of the active cooperative target object is transferred via a sidelink.

TABLE 1

| | |
|---|---|
| Initiating device | Terminal device |
| Computing device | Terminal device |

Link for transferring the status information: active cooperative
target object −> terminal device
Information required for calculating the error compensation parameter:
status information of the terminal device, the status information of
the active cooperative target object, and measurement information of
the active cooperative target object

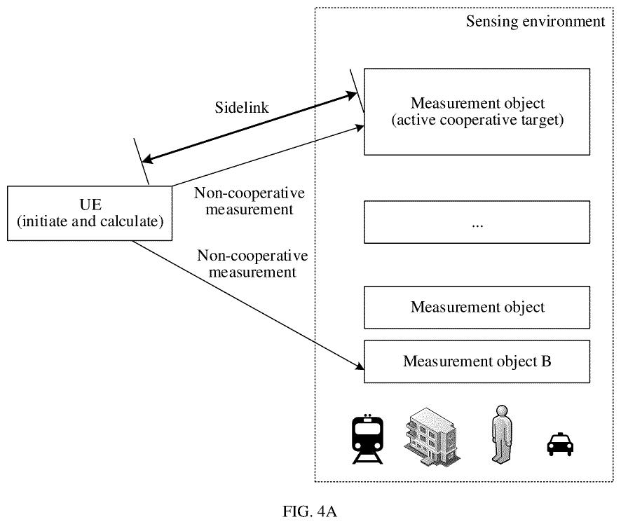

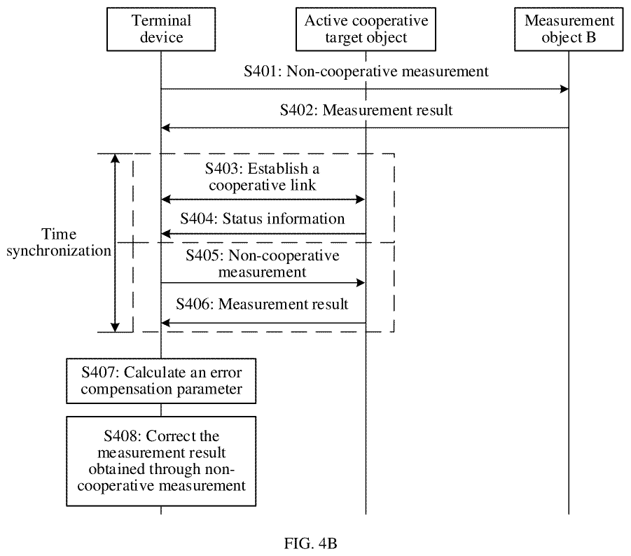

This example is applicable to a communication system shown in 4A. As shown in FIG. 4A, the terminal device is UE, and the UE may interact with the active cooperative target object via a sidelink.

The following describes a method and steps or operations for error compensation with reference to a flowchart shown in FIG. 4B.

S401: the terminal device may measure the measurement object B according to a non-cooperative measurement method.

S402: based on step or operation S401, the terminal device obtains a measurement result, where the measurement result includes measurement information of the measurement object B. It may be understood that the measurement information of the measurement object B obtained in step or operation S402 is uncorrected, for example, the measurement information has a system error.

S403: the terminal device may establish a cooperative link with the active cooperative target object.

S404: the terminal device receives, via the cooperative link in step or operation S403, status information, ID information, and timestamp information that are reported by the active cooperative target object, where the status information is the foregoing first status information.

The actions in step or operation S403 and step or operation S404 may be the same as those in Manner A in step or operation S202, and details are not described herein again.

S405: the terminal device may measure the active cooperative target object according to the non-cooperative measurement method.

S406: based on step or operation S405, the terminal device obtains a measurement result, where the measurement result includes measurement information of the active cooperative target object.

The actions in step or operation S405 and step or operation S406 may be the same as those in Manner 1 in step or operation S201, and details are not described herein again.

It may be understood that step or operation S403 and step or operation S404 may be performed synchronously with step or operation S405 and step or operation S406 in terms of time. Step or operation S404 is implemented based on step or operation S403, and step or operation S406 is implemented based on step or operation S405.

S407: the terminal device calculates an error compensation parameter based on status information of the terminal device, the status information of the active cooperative target object determined in step or operation S404, and the measurement information of the active cooperative target object determined in step or operation S406.

The action in step or operation S407 may be the same as the action in step or operation S203, and details are not described herein again.

S408: the terminal device may correct, based on the error compensation parameter in step or operation S407, the measurement information obtained through non-cooperative measurement. For example, the terminal device may re-perform steps or operations S401 and S402, and correct the measurement result.

According to the procedure in Example 1, the terminal device may initiate the error compensation calculation procedure, calculate the error compensation parameter, and correct the measurement result obtained through non-cooperative measurement, thereby improving accuracy of the measurement information obtained by the terminal device through non-cooperative measurement, and improving communication performance.

### Example 2

It is assumed that a measurement object C is any measurement object in the sensing environment shown in FIG. 1, and an active cooperative target object is a measurement object whose status information is known. As shown in the following Table 2, in this example, a terminal device initiates an error compensation calculation procedure, and calculates an error compensation parameter. In this example, status information of the active cooperative target object is transferred through transit via a Uu link. The Uu link is a communication link between the terminal device and a network node.

TABLE 2

| | |
|---|---|
| Initiating device | Terminal device |
| Computing device | Terminal device |

Link for transferring the status information: active cooperative
target object −> network device
Information required for calculating the error compensation parameter:
status information of the terminal device, the status information of
the active cooperative target object, and measurement information of
the active cooperative target object

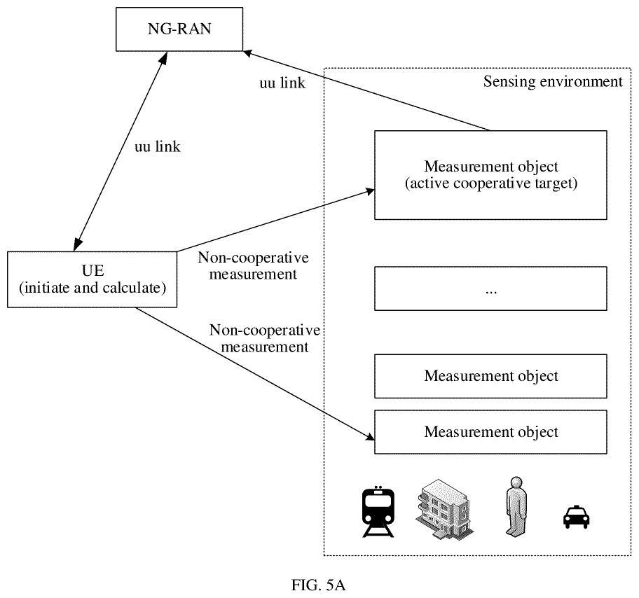

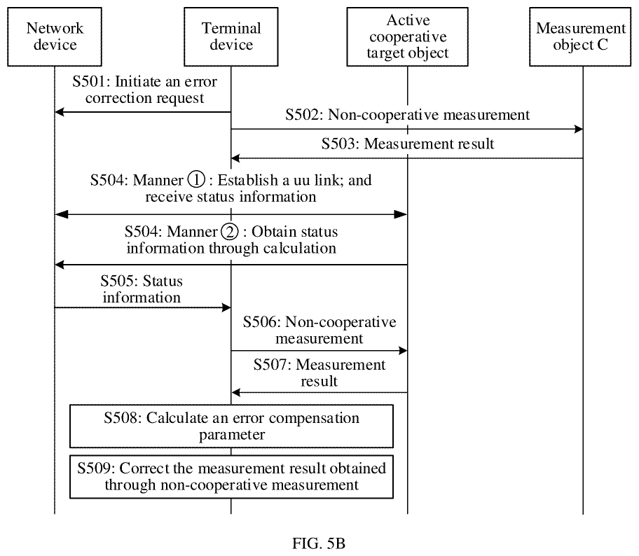

Based on the communication system shown in FIG. 1, this example provides a communication system shown in FIG. 5A, and Example 2 is applicable to the communication system. As shown in FIG. 5A, the terminal device is UE, the network device is a next generation radio access network (NG-RAN), and an LMF network element may interact with the NG-RAN.

The following describes a method and steps or operations for error compensation with reference to a flowchart shown in FIG. 5B.

S501: the terminal device sends an error correction request to the network device via an air interface.

For example, the action in step or operation S501 may be the same as that in Case 1 of Manner C in step or operation S202, and details are not described herein again.

S502: the terminal device may measure the measurement object C according to a non-cooperative measurement method.

S503: based on step or operation S502, the terminal device obtains a measurement result, where the measurement result includes measurement information of the measurement object C. It may be understood that the measurement information of the measurement object C obtained in step or operation S503 is uncorrected, for example, the measurement information has a system error.

S504: the network device obtains, in the following Manner \textcircled{1} or Manner \textcircled{2}, status information reported by the active cooperative target object.

Manner \textcircled{1}: the network device may establish a Uu link with the active cooperative target object, and receive, via the Uu link, the status information, ID information, and timestamp information that are reported by the active cooperative target object, where the status information is the foregoing first status information.

Manner \textcircled{2}: the network device obtains the status information of the active cooperative target object through calculation.

The action in Manner: \textcircled{1} may be the same as that in Manner A in step or operation S202, and the action in Manner \textcircled{2} is the same as that in Manner B in step or operation S202. Details are not described herein again.

S505: the network device sends, to the terminal device, the status information reported by the active cooperative target object; and correspondingly, the terminal device receives, from the network device, the status information reported by the active cooperative target object.

S506: the terminal device may measure the active cooperative target object according to the non-cooperative measurement method.

S507: based on step or operation S506, the terminal device obtains a measurement result, where the measurement result includes measurement information of the active cooperative target object.

The actions in step or operation S506 and step or operation S507 may be the same as those in Manner 1 in step or operation S201, and details are not described herein again.

S508: the terminal device calculates an error compensation parameter based on the status information of the active cooperative target object determined in step or operation S505 and the measurement information of the active cooperative target object determined in step or operation S507.

The action in step or operation S508 may be the same as the action in step or operation S203, and details are not described herein again.

S509: the terminal device may correct, based on the error compensation parameter in step or operation S508, the measurement information obtained through non-cooperative measurement. For example, the terminal device may re-perform steps or operations S502 and S503, and correct the measurement result.

According to the procedure in Example 2, the terminal device may initiate the error compensation calculation procedure, and the network device may assist in obtaining the status information of the active cooperative target object, so that the terminal device can calculate the error compensation parameter, and correct the measurement result obtained through non-cooperative measurement, thereby improving accuracy of the measurement information obtained by the terminal device through non-cooperative measurement, and improving communication performance.

### Example 3

It is assumed that a measurement object D is any measurement object in the sensing environment shown in FIG. 1, and an active cooperative target object is a measurement object whose status information is known. As shown in the following Table 3, in this example, a terminal device initiates an error compensation calculation procedure, and an LMF network element calculates an error compensation parameter. In this example, status information of the active cooperative target object is transferred via a Uu link between the LMF network element and the active cooperative target object.

TABLE 3

| | |
|---|---|
| Initiating device | Terminal device |
| Computing device | LMF network element |

Link for transferring the status information: active cooperative
target object −> LMF network element
Information required for calculating the error compensation
parameter: status information of the terminal device, the status
information of the active cooperative target object, and
measurement information of the active cooperative target object

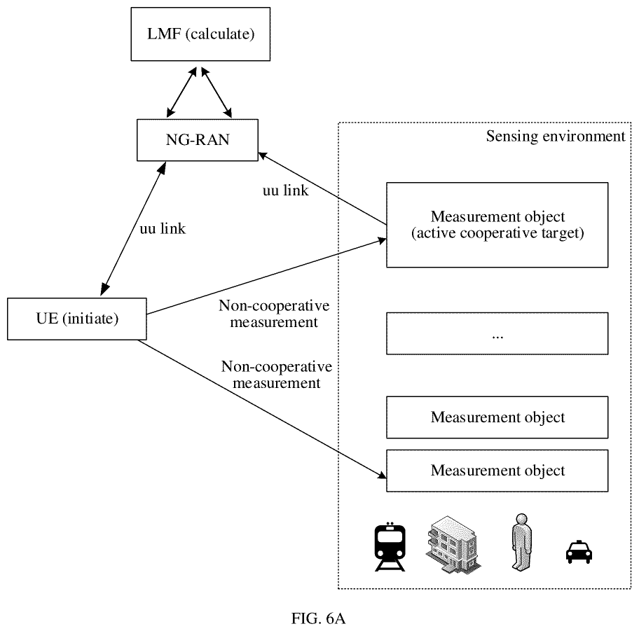

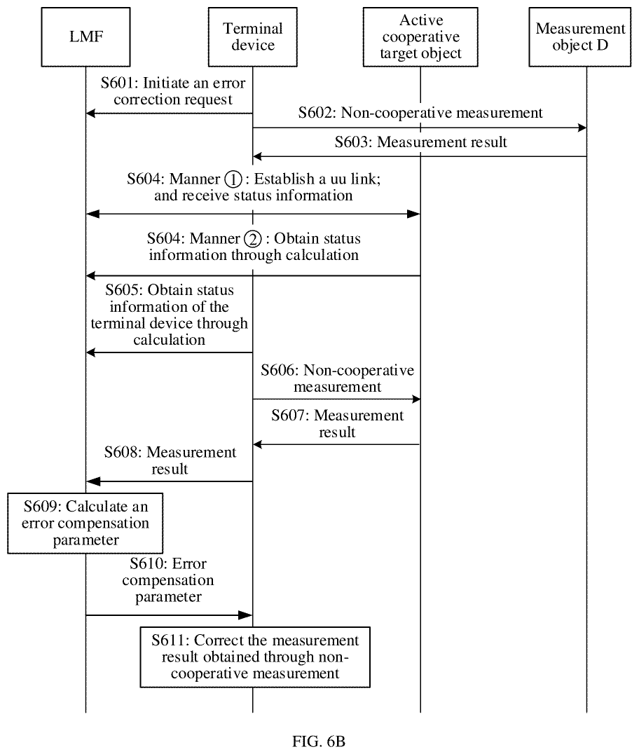

Based on the communication system shown in FIG. 1, this example provides a communication system shown in FIG. 6A, and Example 3 is applicable to the communication system. As shown in FIG. 6A, the terminal device is UE, a network device is an NG-RAN, the LMF network element may interact with the NG-RAN, and the UE may interact with the active cooperative target object through transit via a Uu link.

The following describes a method and steps or operations for error compensation with reference to a flowchart shown in FIG. 6B.

S601: the terminal device sends an error correction request to the LMF network element.

For example, the action in step or operation S601 may be the same as that in Case 1 of Manner C in step or operation S202, and details are not described herein again.

S602: the terminal device may measure the measurement object D according to a non-cooperative measurement method.

S603: based on step or operation S602, the terminal device obtains a measurement result, where the measurement result includes measurement information of the measurement object D. It may be understood that the measurement information of the measurement object D obtained in step or operation S603 is uncorrected, for example, the measurement information has a system error.

S604: the LMF network element obtains, in the following Manner \textcircled{1} or Manner \textcircled{2}, status information reported by the active cooperative target object.

Manner \textcircled{1}: the LMF network element may establish a Uu link with the active cooperative target object, and receive, via the Uu link, the status information, ID information, and timestamp information that are reported by the active cooperative target object, where the status information is the foregoing first status information.

Manner \textcircled{2}: the LMF network element obtains the status information of the active cooperative target object through calculation.

The action in Manner \textcircled{1} may be the same as that in Manner A in step or operation S202, and the action in Manner \textcircled{2} is the same as that in Manner B in step or operation S202. Details are not described herein again.

S605: the LMF network element obtains status information of the terminal device through calculation, where the status information is the foregoing node status information.

The action in step or operation S605 may be the same as or different from that in step or operation 1 in step or operation S203, and details are not described herein again.

S606: the terminal device may measure the active cooperative target object according to the non-cooperative measurement method.

S607: based on step or operation S606, the terminal device obtains a measurement result, where the measurement result includes measurement information of the active cooperative target object.

The actions in step or operation S606 and step or operation S607 may be the same as those in Manner 1 in step or operation S201, and details are not described herein again.

S608: the terminal device sends the measurement information determined in step or operation S607 to the LMF network element. Correspondingly, the LMF network element receives the measurement information from the terminal device.

S609: the LMF network element calculates an error compensation parameter based on the status information of the active cooperative target object determined in step or operation S604, the status information of the terminal device determined in step or operation S605, and the measurement information of the active cooperative target object determined in step or operation S607.

The action in step or operation S609 may be the same as the action in step or operation 2 in step or operation S203, and details are not described herein again.

S610: the LMF network element sends the error compensation parameter to the terminal device.

S611: the terminal device may correct, based on the error compensation parameter in step or operation S609, the measurement information obtained through non-cooperative measurement. For example, the terminal device may re-perform steps or operations S602 and S603, and correct the measurement result.

According to the procedure in Example 3, the terminal device may initiate the error compensation calculation procedure, and the network device may obtain the status information of the active cooperative target object, and calculate the error compensation parameter, so that the terminal device can correct, based on the error compensation parameter, the measurement result obtained through non-cooperative measurement, thereby improving accuracy of the measurement information obtained by the terminal device through non-cooperative measurement, and improving communication performance.

### Example 4

It is assumed that a measurement object E is any measurement object in the sensing environment shown in FIG. 1, and an active cooperative target object is a measurement object whose status information is known. As shown in the following Table 4, in this example, an LMF network element initiates an error compensation calculation procedure, and a terminal device calculates an error compensation parameter. In this example, status information of the active cooperative target object is transferred via a Uu link between the LMF network element and the active cooperative target object.

TABLE 4

| | |
|---|---|
| Initiating device | LMF network element |
| Computing device | Terminal device |

Link for transferring the status information: active cooperative
target object −> LMF network element
Information required for calculating the error compensation
parameter: status information of the terminal device, the status
information of the active cooperative target object, and
measurement information of the active cooperative target object

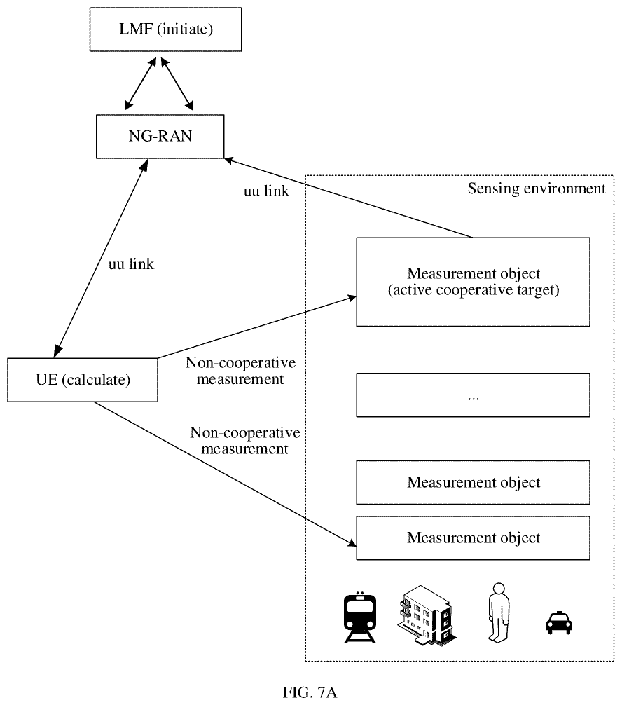

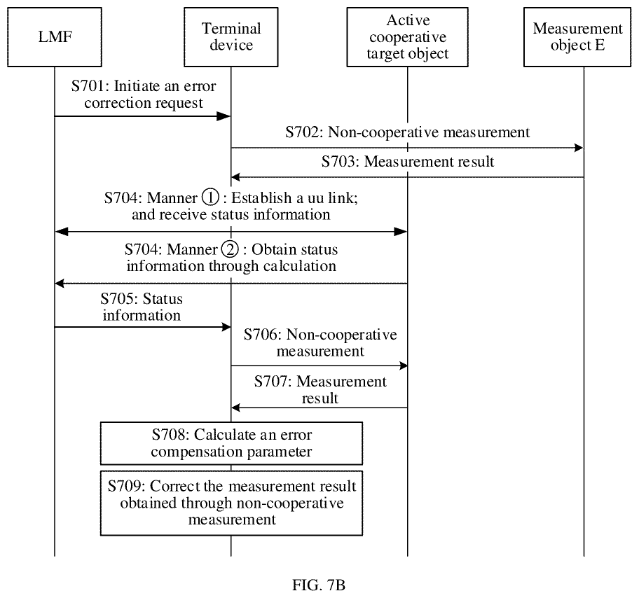

Based on the communication system shown in FIG. 1, this example provides a communication system shown in FIG. 7A, and Example 4 is applicable to the communication system. As shown in FIG. 7A, the terminal device is UE, a network device is an NG-RAN, the LMF network element may interact with the NG-RAN, and the UE may interact with the active cooperative target object through transit via a Uu link.

The following describes a method and steps or operations for error compensation with reference to a flowchart shown in FIG. 7B.

S701: the LMF network element sends an error correction request to the terminal device.

For example, the action in step or operation S701 may be the same as that in Case 2 of Manner C in step or operation S202, and details are not described herein again.

S702: the terminal device may measure the measurement object E according to a non-cooperative measurement method.

S703: based on step or operation S702, the terminal device obtains a measurement result, where the measurement result includes measurement information of the measurement object E. It may be understood that the measurement information of the measurement object E obtained in step or operation S703 is uncorrected, for example, the measurement information has a system error.

S704: the LMF network element obtains, in Manner \textcircled{1} or Manner \textcircled{2}, status information reported by the active cooperative target object.

Manner \textcircled{1}: the LMF network element may establish a Uu link with the active cooperative target object, and receive, via the Uu link, the status information, ID information, and timestamp information that are reported by the active cooperative target object, where the status information is the foregoing first status information.

Manner \textcircled{2}: the LMF network element obtains the status information of the active cooperative target object through calculation.

The action in Manner \textcircled{1} may be the same as that in Manner A in step or operation S202, and the action in Manner \textcircled{2} is the same as that in Manner B in step or operation S202. Details are not described herein again.

S705: the LMF network element sends, to the terminal device, the status information reported by the active cooperative target object; and correspondingly, the terminal device receives, from the LMF network element, the status information reported by the active cooperative target object.

S706: the terminal device may measure the active cooperative target object according to the non-cooperative measurement method.

S707: based on step or operation S706, the terminal device obtains a measurement result, where the measurement result includes measurement information of the active cooperative target object.

The actions in step or operation S706 and step or operation S707 may be the same as those in Manner 1 in step or operation S201, and details are not described herein again.

S708: the terminal device calculates an error compensation parameter based on the status information determined in step or operation S705 and the measurement information of the active cooperative target object determined in step or operation S707.

The action in step or operation S708 may be the same as the action in step or operation S203, and details are not described herein again.

S709: the terminal device may correct, based on the error compensation parameter in step or operation S708, the measurement information obtained through non-cooperative measurement. For example, the terminal device may re-perform steps or operations S702 and S703, and correct the measurement result.

According to the procedure in Example 4, the network device may initiate the error compensation calculation procedure, and assist the terminal device in obtaining the status information of the active cooperative target object, and the terminal device may calculate the error compensation parameter based on the status information of the active cooperative target object, and correct the measurement result obtained through non-cooperative measurement, thereby improving accuracy of the measurement information obtained by the terminal device through non-cooperative measurement, and improving communication performance.

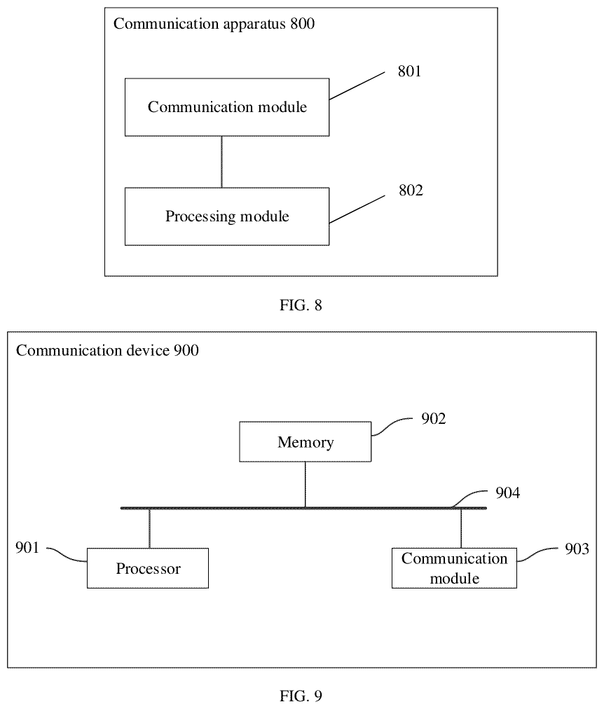

Based on a same concept, the embodiments further provide a communication apparatus. The communication apparatus may be used in the communication system shown in FIG. 1, to implement the error compensation parameter calculation method provided in the foregoing embodiments. As shown in FIG. 8, the communication apparatus 800 includes a communication module 801 and a processing module 802.

The communication module 801 is configured to receive and send data. Optionally, the communication module 801 may include a communication interface and/or a transceiver.

The processing module 802 is configured to perform, based on the communication module, steps or operations performed by the first node in the error compensation parameter calculation method provided in the foregoing embodiments. For a function of the processing module 802, refer to related descriptions in the foregoing embodiments. Details are not described herein again.

In an embodiment, the processing module 802 is configured to: obtain first measurement information of a first measurement object, where the first measurement information is obtained by measuring the first measurement object according to a first measurement method; obtain first status information of the first measurement object; and calculate an error compensation parameter based on the first measurement information and the first status information, where the error compensation parameter is used to correct measurement information that is of a measurement object and that is obtained through measurement according to the first measurement method.

In a possible embodiment, the processing module 802 is further configured to: after calculating the error compensation parameter based on the first measurement information and the first status information, measure a second measurement object according to the first measurement method, to obtain second measurement information; and perform error compensation on the second measurement information based on the error compensation parameter; or the communication module 801 is further configured to send the error compensation parameter to a second node.

In a possible embodiment, the processing module 802 is configured to: receive node status information of a third node from the third node via the communication module 801 and a link between the first node and the third node; or obtain the node status information of the third node through calculation; and calculate the error compensation parameter based on the node status information of the third node, the first measurement information, and the first status information.

In a possible embodiment, the processing module 802 is configured to: measure the first measurement object according to the first measurement method, to obtain the first measurement information; or receive the first measurement information from a fourth node via the communication module 801.

In a possible embodiment, the processing module 802 is configured to: receive the first status information from the first measurement object via the communication module 801 and a link between the first node and the first measurement object; or obtain the first status information through calculation; or receive the first status information from a fifth node via the communication module 801.

In a possible embodiment, the processing module 802 is configured to: send a first request to the fifth node via the communication module 801, where the first request carries an identifier of the first measurement object, and the first request is used to request the first status information of the first measurement object; and receive a first response from the fifth node via the communication module 801, where the first response includes the first status information; or receive a second request from the fifth node via the communication module 801, where the second request carries an identifier of the first measurement object, and the second request indicates the first node to receive the first status information of the first measurement object from the fifth node; and receive a first message from the fifth node via the communication module 801, where the first message includes the first status information.

In a possible embodiment, the error compensation parameter includes at least one of the following: a location error compensation parameter, an attitude angle error compensation parameter, and a measurement error compensation parameter.

In a possible embodiment, the first node is any one of the following: a terminal device, a network device, and an LMF network element.

It may be noted that division into the modules in embodiments is an example, and is logical function division. In some embodiments, there may be another division manner. In addition, functional units in embodiments may be integrated into one processing unit, or may exist alone physically, or two or more units may be integrated into one unit. The integrated unit may be implemented in a form of hardware, or may be implemented in a form of a software functional unit.

When the integrated unit is implemented in a form of a software functional unit and sold or used as an independent product, the integrated unit may be stored in a non-transitory computer-readable storage medium. Based on such an understanding, the solutions of the embodiments, or the part contributing to the conventional technology, or all or some of the solutions may be implemented in a form of a software product. The computer software product is stored in a storage medium and includes several instructions for instructing a computer device (which may be a personal computer, a server, or a network device) or a processor to perform all or some of the steps or operations of the methods described in embodiments. The foregoing storage medium includes any medium that can store program code, such as a USB flash drive, a removable hard disk, a read-only memory (ROM), a random access memory (RAM), a magnetic disk, or an optical disc.

Based on the same concept, an embodiment further provides another communication device. The communication device 900 may implement the error compensation parameter calculation method provided in the foregoing embodiments, and has a function of the processor provided in the foregoing embodiments. As shown in FIG. 9, the communication device 900 includes a memory 902 and a processor 901. Optionally, the communication device 900 further includes a communication module 903. The communication module 903, the processor 901, and the memory 902 are connected to each other. The communication module 903 is configured to receive and send data. The memory 902 is configured to store program instructions and data. The processor 901 is configured to read the program instructions and the data in the memory, to implement the foregoing error compensation parameter calculation method.

For example, the communication device 900 may be the first node shown in embodiments. When the first node is an LMF, the communication module 903 is a communication interface. When the first node is a terminal device, the communication module 903 is a transceiver. When the first node is a network device, the communication module 903 may include a communication interface and a transceiver.

Optionally, the communication module 903, the processor 901, and the memory 902 are connected to each other by using a bus 904. The bus 904 may be a peripheral component interconnect (PCI) bus, an extended industry standard architecture (EISA) bus, or the like. The bus may be classified into an address bus, a data bus, a control bus, or the like. For ease of representation, only one bold line is used for representation in FIG. 9, but this does not mean that there is only one bus or only one type of bus.

The communication module 903 is configured to receive and send data, to implement communication with a device other than the communication device.

For a function of the processor 901, refer to the descriptions in the foregoing embodiments. Details are not described herein again. The processor 901 may be a central processing unit (CPU), a network processor (NP), a combination of a CPU and an NP, or the like. The processor 901 may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), generic array logic (GAL), or any combination thereof. The processor 901 may implement the foregoing functions by using hardware or, in another embodiment, by using hardware executing corresponding software.

The memory 902 is configured to store program instructions and the like. For example, the program instructions may include program code, and the program code includes computer operation instructions. The memory 902 may include a random access memory (RAM), and may further include a non-volatile memory, for example, at least one magnetic disk memory. The processor 901 executes the program instructions stored in the memory 902, to implement the foregoing functions, so as to implement the method provided in the foregoing embodiments. For example, the memory 902 may include the first node shown in embodiments.

Based on the same concept, an embodiment further provides a computer program. When the computer program is run on a computer, the computer is enabled to perform the method provided in the foregoing embodiments.

Based on the same concept, an embodiment further provides a non-transitory computer-readable storage medium. The non-transitory computer-readable storage medium stores a computer program. When the computer program is run on a computer, the computer is enabled to perform the method provided in the foregoing embodiments.

The storage medium may be any usable medium that can be accessed by a computer. By way of example and not limitation, the non-transitory computer-readable medium may include a RAM, a ROM, an EEPROM, a CD-ROM or another optical disk storage, a magnetic disk storage medium or another magnetic storage device, or any other medium that can be used to carry or store expected program code in a form of an instruction or a data structure and that can be accessed by a computer.

Based on the foregoing embodiments, an embodiment further provides a chip. The chip is configured to read a computer program stored in a memory, to implement the method provided in the foregoing embodiments. Optionally, the chip may include a processor and a memory. The processor is coupled to the memory, and configured to read a computer program stored in the memory, to implement the method provided in the foregoing embodiments.

Based on the foregoing embodiments, an embodiment provides a chip system. The chip system includes a processor, configured to support a computer apparatus in implementing the function related to the first node in the foregoing embodiments. In a possible embodiment, the chip system further includes a memory, and the memory is configured to store a program and data that may be for the computer apparatus. The chip system may include a chip, or may include a chip and another discrete component.

A person skilled in the art may understand that embodiments may be provided as a method, a system, or a computer program product. Therefore, the embodiments may be in a form of a hardware-only embodiment, a software-only embodiment, or an embodiment combining software and hardware aspects. In addition, the embodiments may be in a form of a computer program product implemented on one or more computer-usable storage media (including but not limited to a magnetic disk memory, a CD-ROM, an optical memory, and the like) including computer-usable program code.

The embodiments are described with reference to the flowcharts and/or block diagrams of the method, the device (system), and the computer program product according to the embodiments. It may be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a function in one or more processes in the flowcharts and/or in one or more blocks in the block diagrams.

These computer program instructions may alternatively be stored in a non-transitory computer-readable memory that can indicate a computer or another programmable data processing device to work in a manner, so that the instructions stored in the non-transitory computer-readable memory generate an artifact that includes an instruction apparatus. The instruction apparatus implements a function in one or more processes in the flowcharts and/or in one or more blocks in the block diagrams.

These computer program instructions may alternatively be loaded onto a computer or another programmable data processing device, so that a series of operations and steps or operations are performed on the computer or the another programmable device, to generate computer-implemented processing. Therefore, the instructions executed on the computer or the another programmable device provide steps or operations for implementing a function in one or more processes in the flowcharts and/or in one or more blocks in the block diagrams.

It may be understood that a person skilled in the art may make various modifications and variations to the embodiments described herein without departing from the spirit of the embodiments. Thus, the embodiments described herein may cover such modifications and variations, provided that they fall within the scope of the embodiments and equivalent technologies described herein.

1. A method, comprising:
obtaining, by a first node, first measurement information of a first measurement object, wherein the first measurement information is obtained by measuring the first measurement object according to a first measurement method;
obtaining, by the first node, first status information of the first measurement object; and
calculating, by the first node, an error compensation parameter based on the first measurement information and the first status information, wherein the error compensation parameter is used to correct measurement information that is of a measurement object and that is obtained through measurement according to the first measurement method.

2. The method according to claim 1, further comprising:
after calculating, by the first node, the error compensation parameter based on the first measurement information and the first status information,
measuring, by the first node, a second measurement object according to the first measurement method, to obtain second measurement information; and performing, by the first node, error compensation on the second measurement information based on the error compensation parameter; or
sending, by the first node, the error compensation parameter to a second node.

3. The method according to claim 1, wherein calculating, by the first node, the error compensation parameter based on the first measurement information and the first status information comprises:
receiving, by the first node, node status information of a third node from the third node via a link between the first node and the third node; or obtaining, by the first node, the node status information of the third node through calculation; and
calculating, by the first node, the error compensation parameter based on the node status information of the third node, the first measurement information, and the first status information.

4. The method according to claim 1, wherein obtaining, by the first node, the first measurement information of the first measurement object comprises:
measuring, by the first node, the first measurement object according to the first measurement method, to obtain the first measurement information; or
receiving, by the first node, the first measurement information from a fourth node.

5. The method according to claim 1, wherein obtaining, by the first node, the first status information of the first measurement object comprises:
receiving, by the first node, the first status information from the first measurement object via a link between the first node and the first measurement object; or
obtaining, by the first node, the first status information through calculation; or
receiving, by the first node, the first status information from a fifth node.

6. The method according to claim 5, wherein receiving, by the first node, the first status information from the fifth node comprises:
sending, by the first node, a first request to the fifth node, wherein the first request carries an identifier of the first measurement object, and the first request is used to request the first status information of the first measurement object; and receiving, by the first node, a first response from the fifth node, wherein the first response comprises the first status information; or
receiving, by the first node, a second request from the fifth node, wherein the second request carries an identifier of the first measurement object, and the second request indicates the first node to receive the first status information of the first measurement object from the fifth node; and receiving, by the first node, a first message from the fifth node, wherein the first message comprises the first status information.

7. The method according to claim 1, wherein the error compensation parameter comprises at least one of:
a location error compensation parameter, an attitude angle error compensation parameter, and a measurement error compensation parameter.

8. The method according to claim 1, wherein the first node is any one of:
a terminal device, a network device, and a location management function (LMF) network element.

9. A communication apparatus, used in a first node, the apparatus comprising:
a communication module, configured to receive and send data; and
a processing module, configured to: obtain first measurement information of a first measurement object, wherein the first measurement information is obtained by measuring the first measurement object according to a first measurement method; obtain first status information of the first measurement object; and calculate an error compensation parameter based on the first measurement information and the first status information, wherein the error compensation parameter is used to correct measurement information that is of a measurement object and that is obtained through measurement according to the first measurement method.

10. The apparatus according to claim 9, wherein the processing module is further configured to: after calculating the error compensation parameter based on the first measurement information and the first status information, measure a second measurement object according to the first measurement method, to obtain second measurement information; and perform error compensation on the second measurement information based on the error compensation parameter; or send the error compensation parameter to a second node via the communication module.

11. The apparatus according to claim 9, wherein the processing module is configured to:
receive node status information of a third node from the third node via the communication module and a link between the first node and the third node; or obtain the node status information of the third node through calculation; and
calculate the error compensation parameter based on the node status information of the third node, the first measurement information, and the first status information.

12. The apparatus according to claim 9, wherein the processing module is configured to:
measure the first measurement object according to the first measurement method, to obtain the first measurement information; or
receive the first measurement information from a fourth node via the communication module.

13. The apparatus according to claim 9, wherein the processing module is configured to:
receive the first status information from the first measurement object via the communication module and a link between the first node and the first measurement object; or
obtain the first status information through calculation; or
receive the first status information from a fifth node via the communication module.

14. The apparatus according to claim 13, wherein the processing module is configured to:
send a first request to the fifth node via the communication module, wherein the first request carries an identifier of the first measurement object, and the first request is used to request the first status information of the first measurement object; and receive a first response from the fifth node via the communication module, wherein the first response comprises the first status information; or
receive a second request from the fifth node via the communication module, wherein the second request carries an identifier of the first measurement object, and the second request indicates the first node to receive the first status information of the first measurement object from the fifth node; and receive a first message from the fifth node via the communication module, wherein the first message comprises the first status information.

15. The apparatus according to claim 9, wherein the error compensation parameter comprises at least one of:
a location error compensation parameter, an attitude angle error compensation parameter, and a measurement error compensation parameter.

16. The apparatus according to claim 9, wherein the first node is one of:
a terminal device, a network device, and a location management function (LMF) network element.

17. A non-transitory computer-readable storage medium storing instructions that, when executed by one or more processors, cause a communication apparatus to:
obtain first measurement information of a first measurement object, wherein the first measurement information is obtained by measuring the first measurement object according to a first measurement method;
obtain first status information of the first measurement object; and
calculate an error compensation parameter based on the first measurement information and the first status information, wherein the error compensation parameter is used to correct measurement information that is of a measurement object and that is obtained through measurement according to the first measurement method.

18. The non-transitory computer-readable storage medium according to claim 17,
wherein the instructions, when executed, further cause the communication apparatus to, after calculating the error compensation parameter based on the first measurement information and the first status information,
measure a second measurement object according to the first measurement method to obtain second measurement information, and perform error compensation on the second measurement information based on the error compensation parameter; or
send the error compensation parameter to a second node.

19. The non-transitory computer-readable storage medium according to claim 17,
wherein the instructions, when executed, further cause the communication apparatus to receive node status information of a third node from the third node via a communication link between the first node and the third node, or obtain the node status information of the third node through calculation, and calculate the error compensation parameter based on the node status information of the third node, the first measurement information, and the first status information.

20. The non-transitory computer-readable storage medium according to claim 17,
wherein the instructions, when executed, further cause the communication apparatus to measure the first measurement object according to the first measurement method to obtain the first measurement information, or receive the first measurement information from a fourth node via a communication module.
